(19) United States
(12) Patent Application Publication
(10) Pub. No.: US 2007/0251058 A1
(43) Pub. Date: Nov. 1, 2007

(54) Hinge with damper

(76) Inventors: Helmut Fitz, Lustenau (AT); Harald Sutterlutti, Fussach (AT)

Correspondence Address: WENDEROTH, LIND & PONACK, L.L.P., 2033 K STREET N. W., SUITE 800, WASHINGTON, DC, 20006-1021, US

(21) Appl. No.: 11/798,730

(22) Filed: May 16, 2007

Related U.S. Application Data
(63) Continuation of application No. PCT/AT05/00462, filed on Nov. 16, 2005.

(30) Foreign Application Priority Data
Nov. 22, 2004 (AT) A 1952/2004
Mar. 8, 2005 (AT) A 396/2005

(51) Int. Cl. E05F 1/08

(52) U.S. Cl. 16/287

(57) ABSTRACT

The invention relates to a hinge, particularly for movable furniture parts (1), comprising: at least seven rotational pins; at least two stop parts (2, 3) for fastening to furniture parts (1) or the like, and; a linear damping device for damping an opening and/or closing movement of the hinge. This hinge is designed in such a manner that all components (8, 9) of the linear damping device (7) execute a motion relative to both stop parts (2, 3) during the opening and/or closing movement of the hinge.

The present invention relates to a hinge, in particular for movable furniture parts, with at least seven rotatable axes and at least two fastening parts for securing to furniture parts or the like and with a linear damper to dampen an opening and/or a closing movement of the hinge.

With the linear dampers used in the state of the art to dampen the movement of furniture parts, the maximum stroke is limited. On the other hand, though, it must still be possible to accomplish a certain minimum stroke, in order to achieve the desired smooth damping of the movement. The realisation of these requirements is constantly restricted in practice by the hinge geometry. Consequently, it is often difficult to incorporate a linear damper into the hinge in such a way that on the one hand the damping starts to work at the desired angle and, on the other, there is also sufficient stroke available for the damping not to be too abrupt.

It is an object of the invention to further develop a generic hinge in such a way that these problems are at least largely eliminated.

This is accomplished according to the invention by designing the hinge in such a way that all components of the linear damper perform a relative movement to both fastening parts during the opening and/or closing movement of the hinge.

A basic idea of the invention is therefore to attach a linear damper to at least one fastening part of the hinge in such a way that the linear damper moves relative to both the furniture body and also relative to the furniture doors once the hinge has been assembled. In this way, both the stroke of the linear damper and the moment or opening angle, respectively, at which the linear damper starts to operate are relatively freely set through the choice of geometry for the individual hinge parts. It is favourably provided in this case that the linear damper is, preferably exclusively, supported by or mounted onto intermediate pieces and/or articulated levers that are movable relative to the fastening parts.

Further features and details of the present invention emerge from the following description of the figures. In the figures:

FIGS. 1-3 show a first exemplary embodiment of the invention,

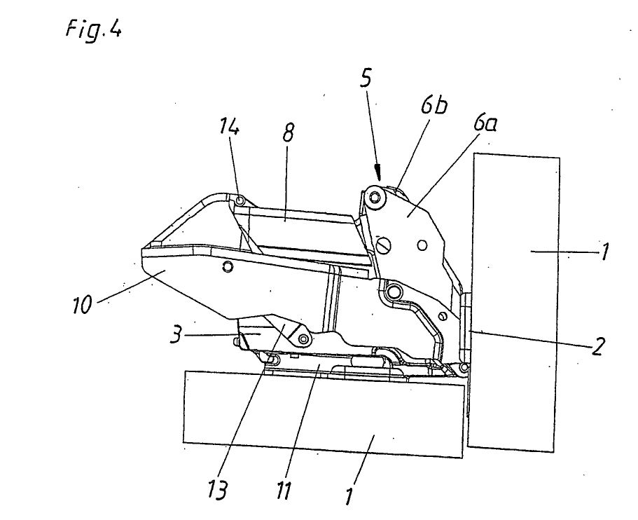

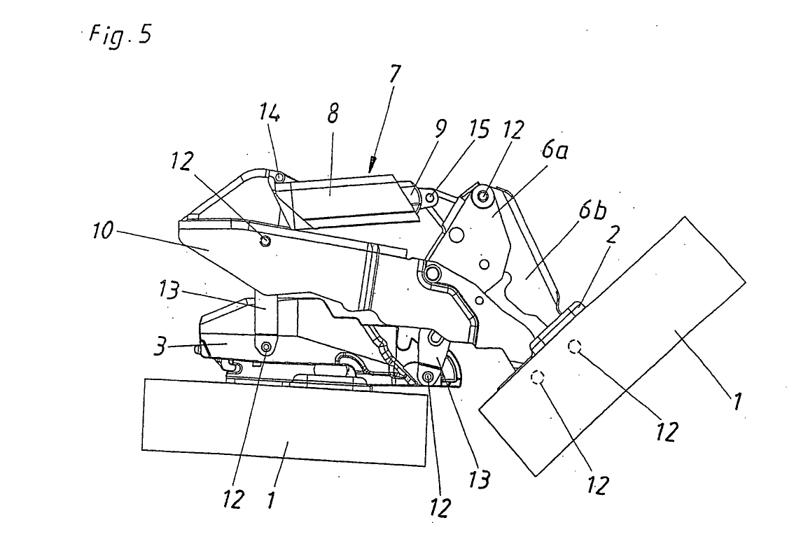

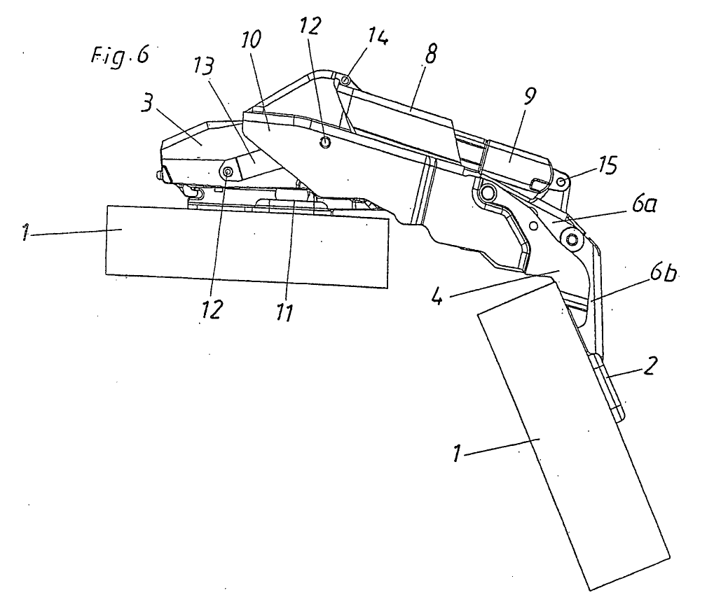

FIGS. 4-6 show a second embodiment according to the invention, and

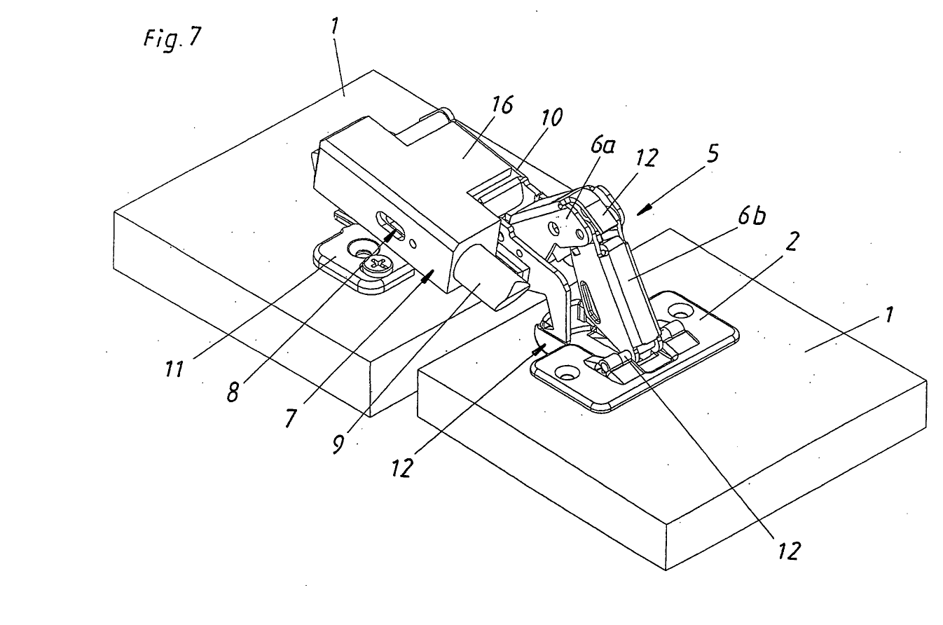

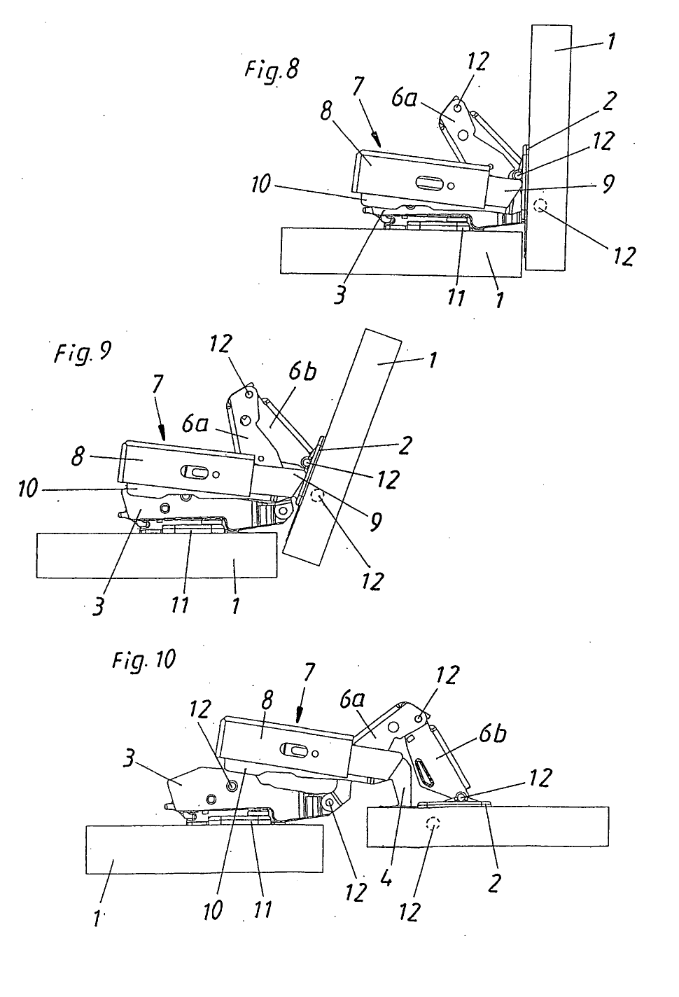

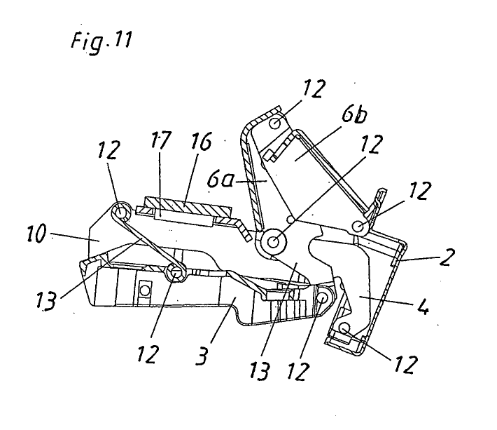

FIGS. 7-11 show a third embodiment according to the invention.

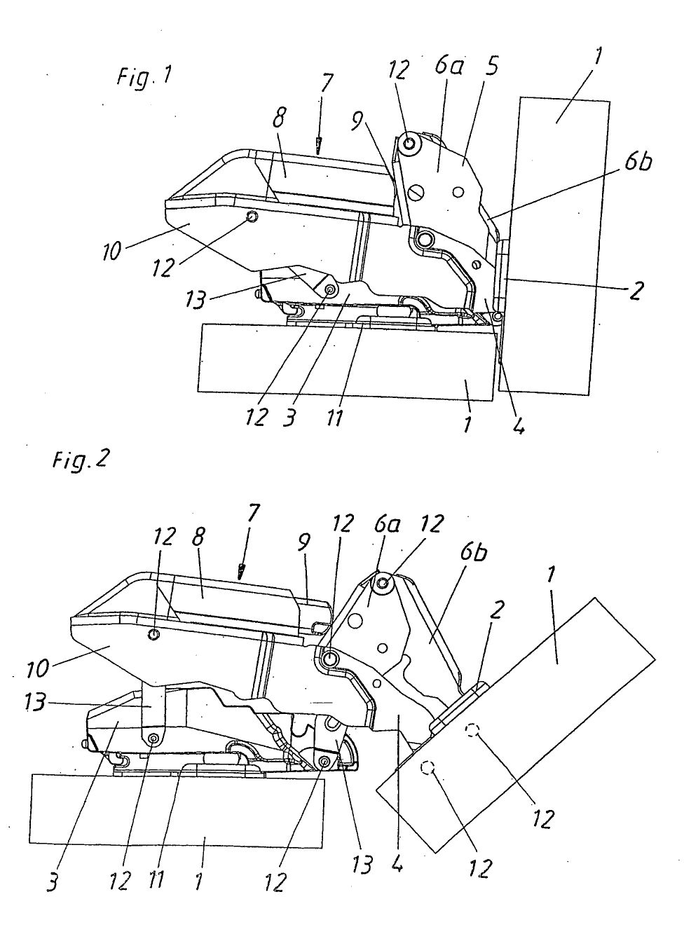

All three embodiments show so-called wide-angle hinges, in which it is particularly favourable for the linear damper to be arranged according to the invention. All hinges have at least seven rotatable axes 12, which can be seen in FIGS. 2, 5 and 11, for instance. The axes 12 in the hinge pot 2, which are actually concealed where necessary in these illustrations, are depicted using a dotted line. In all variants shown here, so-called linear dampers are used. When it comes to choosing a linear damper, there is a wide range of different state-of-the-art models available.

The hinges shown have—as known per se—a hinge arm 3 and a hinge pot 2. These two fastening parts are each secured to or in different furniture parts. The hinge arm 3 is secured on a base plate fixed to the furniture part 1 in a clip-on manner and therefore indirectly fastened to the furniture part. However, the hinge arm 3 can also be fixed directly to the furniture part 1. The two fastening parts 2 and 3 are connected to one another via two articulated levers 4 and 5, wherein the first articulated lever 4 is fixed here in one piece to an intermediate piece 10 and the second articulated lever 5 has two limbs 6a and 6b that can be tilted to one another.

A component of the linear damper 7, in this case the cylinder 8, is disposed on the intermediate piece 10. In the first two exemplary embodiments according to FIGS. 1 to 6, the ram 9 that can be displaced relative to the cylinder 8 is acted upon via the articulated lever 5. In the first exemplary embodiment in accordance with FIGS. 1-3 it only abuts the articulated lever 5 for this purpose. In the second embodiment according to FIGS. 4-6, the ram 9 is permanently connected to the articulated lever 5 via the ram joint 15. In the third embodiment in accordance with FIGS. 7-11, the ram 9 is supported either by a fastening part, in this case the hinge pot 2, or by a furniture part 1 that can be connected to the fastening part. The ram 9 and cylinder 8 may even be the corresponding components of a linear damper, but also simply form the housing components in which a corresponding linear damper known in the state of the art is included.

The intermediate piece 10 is forcibly coupled to a fastening part—in this case the lever arm 3—via two levers 13, wherein the levers 13 are swivel-mounted both on the intermediate piece 10 and also on the fastening part via corresponding axes 12.

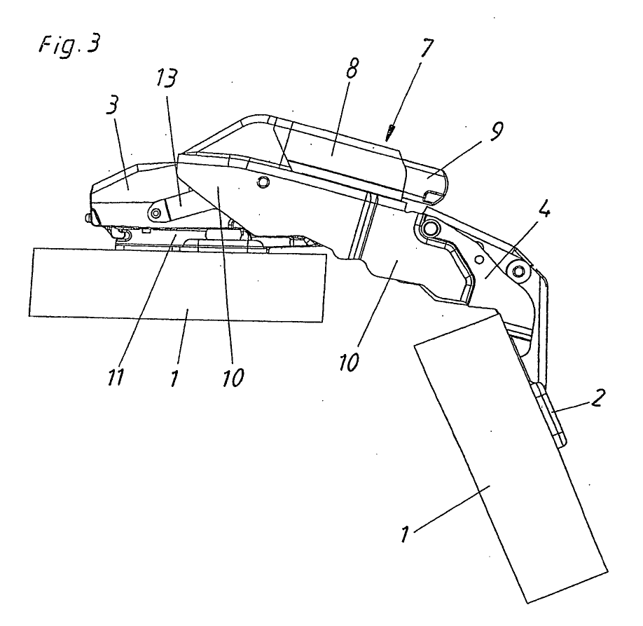

The intermediate piece 10 has an essentially U-shaped profile in all exemplary embodiments, enabling the corresponding fastening part—thus in this case the hinge arm 3—to be at least partly encompassed by the intermediate piece 10. The lever 13 disposed closer to the hinge pot is integrated into the first limb 6a of the articulated lever 5 in all exemplary embodiments. However, this need not necessarily be the case. The function of the intermediate piece 10 and also the lever 13 becomes clear when comparing FIGS. 1 to 3 and 4 to 6 and 8 to 10 with one another. FIGS. 1, 4 and 8 each show a first end position of the hinge, in which the latter is in the closed position. FIGS. 3, 6 and 10 show the open position in each case, while the hinge in FIGS. 2, 5 and 9 is shown in an intermediate position in each case. By means of the intermediate piece 10, it is possible not only to pivot the two furniture parts 1 relative to one another, but also to increase their distance from one another while pivoting. To achieve this, the intermediate piece 10 is tilted away by means of the lever 13 from the first end position in accordance with FIGS. 1, 4 and 8 via the hinge arm 3 and extends the latter in the end position depicted in FIGS. 3, 6 and 10. This enables the two fastening parts 2 and 3 to be at varying distances from one another in the two end positions. The cylinder 8 of the linear damper 7 anchored on the intermediate piece 10 is moved along with the latter. The linear damper 7 may be fixed on the intermediate piece 10, as in the first exemplary embodiment, but also pivotably secured to the intermediate piece 10 via a joint 14, as in the second exemplary embodiment.

In the third exemplary embodiment, the linear damper 7, in this case with its cylinder 8, is detachably secured, in this case by clip-on means, to the intermediate piece 10. A mounting plate, which in turn has a latching element 17, is disposed for this on the linear damper 7. This can snap into a corresponding recess in the intermediate piece 10 and is then detachably secured to it. Equally good, however, is a solution whereby the linear damper 7, preferably once again via its cylinder 8, can be detachably secured to or mounted on one of the articulated levers. In the third exemplary embodiment according to FIGS. 7-11, the linear damper 7 and its cylinder 8, in plan view, is disposed on one of the fastening parts 2, 3 to the side of the centre of the fastening part, thus in this case essentially alongside a fastening part designed as a hinge arm 3. It can be seen from the sectional representation in FIG. 11 that with this embodiment the rear lever 13 is disposed within the hinge arm 3 and within the intermediate piece 10, while in the first two embodiments according to FIGS. 1-6 it is disposed outside on the hinge arm 3.

Overall according to the invention, all components 8, 9 of the linear damper 7 perform a relative movement to both fastening parts 2 and 3 during the opening and/or closing movement. By means of this measure, both the desired stroke and also the initial position at which the damping starts are very freely settable through a corresponding choice of geometry.

1. A hinge for movable furniture parts comprising:
at least two fastening parts for securing said hinge to said furniture parts,
at least seven rotatable axes,
a linear damper for damping at least one selected from the group consisting of an opening movement and a closing movement of said hinge,
wherein said hinge is designed such that all components of said linear damper perform a relative movement to both said fastening parts during at least one selected from the group consisting of said opening movement and said closing movement of said hinge.

2. The hinge according to claim 1, wherein said hinge is a wide-angle hinge.

3. The hinge according to claim 1, wherein said linear damper is supported by or mounted on at least one selected from the group consisting of intermediate pieces and articulated levers that are movable relative to said fastening parts.

4. The hinge according to claim 3, wherein said linear damper is exclusively supported or mounted on at least one selected from the group consisting of intermediate pieces and articulated levers that are movable relative to said fastening parts.

5. The hinge according to claim 3, wherein said linear damper comprises a ram which is acted upon by one of said articulated levers.

6. The hinge according to claim 5, wherein said ram is pivotably mounted on said articulated lever via a ram joint.

7. The hinge according to claim 6, wherein said articulated lever on which said ram of said linear damper is supported comprises at least two limbs that can be tilted to one another.

8. The hinge according to claim 1, wherein said linear damper comprises a ram, which can be acted upon by at least one of the group consisting of said fastening parts and said furniture part that can be disposed on one of said fastening parts.

9. The hinge according to claim 8, wherein said fastening part is a hinge pot of said hinge.

10. The hinge according to claim 1, wherein a component of said linear damper is disposed on an intermediate piece, wherein said intermediate piece is forcibly coupled to one of said fastening parts via at least two levers, wherein said levers are pivotably mounted on said intermediate piece and pivotably mounted on said fastening part.

11. The hinge according to claim 10, wherein said component of said linear damper is pivotably mounted on said intermediate piece.

12. The hinge according to claim 10, wherein said component of said linear damper is a cylinder.

13. The hinge according to claim 10, wherein said fastening part is a hinge arm which can be fixed to said furniture part either directly or via a base plate.

14. The hinge according to claim 13, wherein said intermediate piece has an essentially U-shaped profile, wherein said fastening part is at least partly encompassed by said intermediate piece.

15. The hinge according to claim 14, wherein said fastening part is a hinge arm.

16. The hinge according to claim 10, wherein said intermediate piece can adopt at least two end positions relative to said fastening part with which it is forcibly coupled via said levers, wherein said fastening parts are further apart from one another in the one end position than in the other.

17. The hinge according to claim 1, wherein said linear damper—in plan view—is disposed on one of said fastening parts to the side of the centre of said fastening parts.

18. The hinge according to claim 17, wherein said linear damper is disposed essentially alongside said fastening part designed as a hinge arm.

19. The hinge according to claim 17, wherein said cylinder of said damper—in plan view—is disposed on one of said fastening parts to the side of the centre of said fastening parts.

20. The hinge according claim 3, wherein said linear damper is detachably mounted on or secured to at least one selected from the group consisting of said intermediate piece and said articulated lever.

21. The hinge according to claim 20, wherein said damper is detachably mounted on or secured to at least one selected from the group consisting of said intermediate piece and said articulated lever by clip-on means.
